(19) United States
(12) Patent Application Publication
(10) Pub. No.: US 2007/0296708 A1
(43) Pub. Date: Dec. 27, 2007

(54) Computer System

(76) Inventor: Mon-Yang Lu, Taipei (TW)

Correspondence Address: LAW OFFICES OF LAI AND ASSOCIATES, P.C., 5800 RANCHESTER STE 200, HOUSTON, TX, 77036, US

(21) Appl. No.: 11/426,168

(22) Filed: Jun. 23, 2006

(51) Int. Cl. G06F 3/041

(52) U.S. Cl. 345/173

(57) ABSTRACT

A computer system includes a computer apparatus host, a flat display device, and a touch panel so as to increase more conveniences in operating and watching. The flat display device of the system is electrically connected to the computer apparatus host and is selectively rotated on the computer host. The touch panel includes an input function, and provides a display function based on the rotation performed by the flat display device.

### FIELD OF THE INVENTION

The present invention relates to a computer system, and more particularly to use a touch panel to provide an input function and a display function. The touch panel is for displaying the same data or the different data as the flat display device.

### BACKGROUND OF THE INVENTION

A computer apparatus is in widespread use, especially in business affairs. When a user discusses or introduces a product with a customer, the computer apparatus could provide presentations and display multimedia data so as to become an important instrument. A screen of the computer apparatus and operation functions could provide a detail illustration for the customer. The computer apparatus may also archive data for future use without carrying complex documents and data. However, both the user and the customer must sit together to watch a display on the screen. The user is then able to illustrate the display for the customer. The aforesaid way may restrict spaces for the user and the customer. Furthermore, the user may not easily operate the computer apparatus.

Therefore, a computer system is designed. A transparent touch panel of the computer system is utilized to provide a display function so as to provide a plurality of displays simultaneously. The user could watch presentations without space restrictions, thereby increasing more conveniences in operating and watching.

### SUMMARY OF THE INVENTION

Accordingly, in order to watch the display on the screen for both the user and the customer simultaneously without increasing inconveniences in operating and restrictions in spaces, an object of the present invention is to provide a computer system which can increase more conveniences in operating and watching. The system includes a computer apparatus host and a flat display device. A touch panel with a display function is disposed on the system. An input function and the display function are provided by the touch panel. The touch panel is for displaying the same data or the different data as the flat display device.

In accordance with the computer system the computer apparatus host is electrically connected to the flat display device and the touch panel. The flat display device is connected to the computer apparatus host. The touch panel is disposed on the computer apparatus host. The computer apparatus host provides a first display data to the flat display device and provides a second display data to the touch panel. The first display data is the same or differs from the second display data. The flat display device is for displaying the first display data, and is selectively rotated. The touch panel has an input function and a display function through transparent panel design. When the flat display device is rotated to a predetermined angle from the front to the rear or from the right to the left, the display function is activated by the touch panel to display the second display data. When the flat display device rotates to an original position, the touch panel then inactivates the display function.

Other features and advantages of the present invention and variations thereof will become apparent from the following description, drawings, and claims.

### BRIEF DESCRIPTION OF THE DRAWINGS

FIG. 1 is a block diagram illustrating a computer system according to an embodiment of the invention;

FIG. 2 is a schematic diagram illustrating the appearance of the computer system according to a preferred embodiment of the present invention; and

FIG. 3 is a schematic diagram illustrating the appearance of the computer system according to a preferred embodiment of the present invention.

### DETAILED DESCRIPTION OF THE PREFERRED EMBODIMENTS

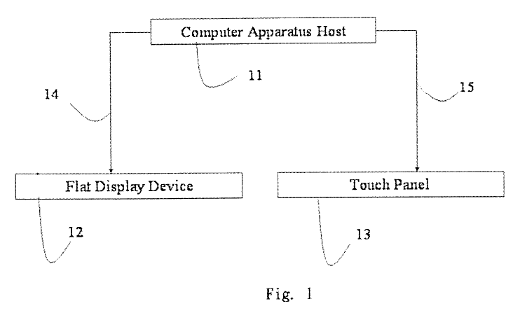

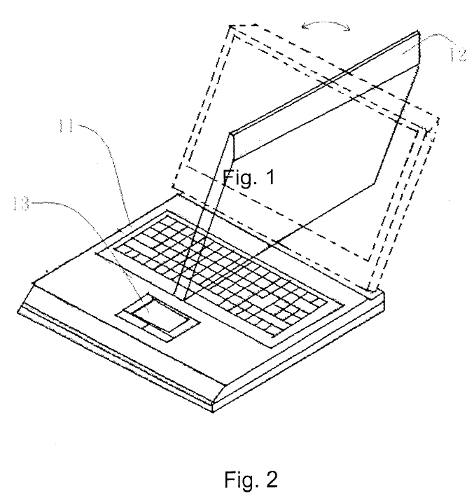

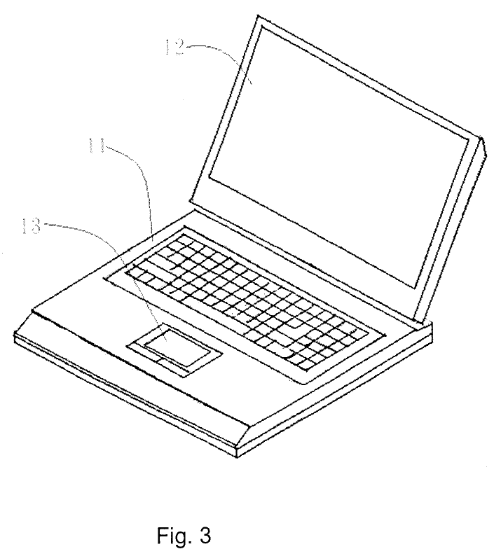

Referring to FIG. 1 to FIG. 3, FIG. 1 is a block diagram illustrating a computer system according to an embodiment of the invention. FIG. 2 and FIG. 3 are schematic diagrams illustrating the appearance of the computer system according to embodiments of the invention. The computer system includes a computer apparatus host 11, a flat display device 12 and a touch panel 13. The computer apparatus host 11 is electrically connected to the flat display device 12 and the touch panel 13 respectively. The flat display device 12 is connected to the computer apparatus host 11. The touch panel 13 is also disposed on the computer apparatus host 11. The computer apparatus host 11 is for providing a first display data 14 to the flat display device 12, and is for providing a second display data 15 to the touch panel 13. The first display data 14 is the same or differs from the second display data 15. The flat display device 12 is for display the first display data 14. The flat display device 12 may use the connection position on the computer apparatus host 11 to selectively rotate. The touch panel 13 has an input function and a display function simultaneously by utilizing transparent panel design. The input function could control the second display data 15, thereby controlling the computer system. As shown in FIG. 2, when the flat display device 12 is rotated to a predetermined angle, the touch panel 13 then activates the display function to display the second display data 15. As shown in FIG. 3, when the flat display device 12 is rotated to an original position, the touch panel 13 then inactivates the display function. In addition, the display function of the touch panel 13 can be controlled by an operation end.

Although the features and advantages of the embodiments according to the preferred invention are disclosed, it is not limited to the embodiments described above, but encompasses any and all modifications and changes within the spirit and scope of the following claims.

What is claimed is:

1. A computer system, comprising:
a computer apparatus host;
a flat display device electrically connected to said computer apparatus host, and selectively performed a rotating motion upon said computer apparatus host; and
a touch panel disposed on said computer apparatus host, and having an input function and a display function simultaneously, and selectively provided said display function based on said rotating motion.

2. The computer system of claim 1, wherein said flat display device is a liquid crystal display.

3. The computer system of claim 1, wherein said computer apparatus host is a personal computer.

4. The computer system of claim 1, wherein said computer apparatus host is a notebook computer.

5. The computer system of claim 1, wherein said rotating motion is to rotate a predetermined angle.

6. The computer system of claim 5, wherein after said rotating motion is rotated to said predetermined angle, said touch panel then provides said display function.

7. The computer system of claim 1, wherein said touch panel is a transparent panel.

8. The computer system of claim 1, wherein after said rotating motion is rotated to said predetermined angle, said computer apparatus host then provides a first display data to said flat display device and provides a second display data to said touch panel.

9. The computer system of claim 8, wherein said first display data is the same as said second display data.

10. The computer system of claim 8, wherein said display data differs from said second display data.
